(19) United States
(12) Patent Application Publication
(10) Pub. No.: US 2025/0153967 A1
(43) Pub. Date: May 15, 2025

(54) APPARATUS AND METHOD FOR MANUFACTURING SECONDARY BATTERY

(71) Applicant: SAMSUNG SDI CO.,LTD., Yongin-si (KR)

(72) Inventors: HYO JEONG KIM, Suwon-si (KR); Chan Hoon Kim, Suwon-si (KR)

(21) Appl. No.: 18/630,043

(22) Filed: Apr. 9, 2024

(30) Foreign Application Priority Data
Nov. 15, 2023 (KR) 10-2023-0158114

(51) Int. Cl. B65H 23/18; H01M 10/058

(52) U.S. Cl. CPC B65H 23/18; B65H 2515/31; B65H 2553/81; H01M 10/058

(57) ABSTRACT

A secondary battery manufacturing apparatus includes at least one roller configured to convey a sheet, at least one sensor configured to measure a tension of the sheet, and a driver configured to control operation of the at least one roller, based on the tension measured by the at least one sensor.

### CROSS-REFERENCE TO RELATED APPLICATION

The present application claims priority and the benefit of Korean Patent Application No. 10-2023-0158114, filed on Nov. 15, 2023, in the Korean Intellectual Property Office, the entire disclosure of which is incorporated herein by reference.

### BACKGROUND

### 1. Field

Embodiments relate to an apparatus and method for manufacturing a secondary battery.

### 2. Description of the Related Art

In recent years, demand for high energy density and high capacity secondary batteries has grown rapidly with rapid spread of electronic devices using batteries, such as mobile phones, notebook computers, and electric vehicles. Thus, research and development have been actively carried out to improve lithium secondary batteries.

A lithium secondary battery may include a cathode, an anode, an electrolyte, and a separator interposed between the cathode and the anode that contain active materials allowing intercalation and deintercalation of lithium ions, and produces electrical energy through oxidation and reduction upon intercalation/deintercalation of lithium ions in the cathode and the anode. A process for manufacturing an electrode plate (e.g., a cathode or an anode) or a separator may include winding, unwinding, or rolling the electrode plate or the separator. In addition, the manufacturing process may also include conveying the electrode plate or the separator between positions in one or more devices that perform various manufacturing operations.

### SUMMARY

In accordance with one aspect of embodiments, there is provided a secondary battery manufacturing apparatus, including a roller conveying a sheet, a sensor measuring tension of the sheet, and a driver controlling operation of the roller based on the measured tension.

The at least one roller may include a first roller and a second roller, and the at least one sensor may be positioned at least at one of a portion of the first roller, a portion of the second roller, and a portion between the first roller and the second roller.

The at least one sensor may include a first sensor on a first side of the at least one roller and a second sensor on a second side of the at least one roller, the first sensor and the second sensor being spaced apart from each other by a predetermined distance.

The driver may be configured to control operation of the at least one roller by controlling at least one of a feeding amount of the at least one roller and a moving angle of the at least one roller based on the tension measured by the at least one sensor.

The driver may be configured to calculate a sum of the tension measured by the at least one sensor, to determine a difference between the sum of the tension measured by the at least one sensor and a target tension, and to control operation of the at least one roller based on whether the difference is within a first range.

If determining that the difference is not within the first range, the driver may be configured to control operation of the at least one roller so as to decrease a feeding amount of the at least one roller if the sum of the tension measured by the at least one sensor is greater than the target tension, and the driver may be configured to control operation of the at least one roller so as to increase the feeding amount of the at least one roller if the sum of the tension measured by the at least one sensor is less than the target tension.

The driver may be configured to determine a ratio of tension in a first direction of the sheet and tension in a second direction of the sheet based on the tension measured by the at least one sensor, and may be configured to control the driving of the at least one roller based on whether the determined ratio is within a second range.

If determining that the determined ratio is not within the second range, the driver may be configured to adjust a moving angle of the at least one roller to a first angle if the tension in the first direction is greater than the tension in the second direction, and the driver may be configured to adjust the moving angle of the at least one roller to a second angle, if the tension in the first direction is less than the tension in the second direction.

The at least one sensor may include a load cell.

In accordance with another aspect of embodiments, there is provided a secondary battery manufacturing method including conveying a sheet through a roller; measuring tension of the sheet through a sensor during conveyance of the sheet; and controlling operation of the roller based on the measured tension through a driver.

The at least one sensor may include a load cell.

Controlling operation of the at least one roller may include calculating a sum of measured tensions, determining a difference between the sum of the measured tensions and a target tension, and controlling operation of the at least one roller based on whether the difference is within a first range.

If determining that the difference is not within the first range, controlling operation of the at least one roller may include controlling operation of the at least one roller so as to decrease a feeding amount of the at least one roller if the sum of the measured tensions is greater than the target tension, and controlling operation of the at least one roller so as to increase the feeding amount of the at least one roller if the sum of the measured tensions is less than the target tension.

Controlling operation of the at least one roller may include determining a difference between a ratio of tension in a first direction of the sheet and tension in a second direction of the sheet based on the measured tension, and controlling operation of the at least one roller based on whether the determined difference is within a second range.

Upon determining that the difference is not within the second range, controlling operation of the at least one roller may include adjusting a moving angle of the at least one roller to a first angle if the tension in the first direction is greater than the tension in the second direction, and adjusting the moving angle of the at least one roller to a second angle if the tension in the first direction is less than the tension in the second direction.

### BRIEF DESCRIPTION OF THE DRAWINGS

Features will become apparent to those of skill in the art by describing in detail exemplary embodiments with reference to the attached drawings, in which:

FIG. 1 to FIG. 4 are schematic views of lithium secondary batteries according to embodiments;

FIG. 5A and FIG. 5B are views of an example of skew failure occurring in a sheet;

FIG. 6 is a schematic view of a secondary battery manufacturing apparatus according to embodiments;

FIG. 7 is a flowchart illustrating a secondary battery manufacturing method according to embodiments;

FIG. 8 is a schematic view of a secondary battery manufacturing apparatus according to embodiments;

FIG. 9 is a flowchart illustrating a secondary battery manufacturing method according to embodiments;

FIG. 10 is a schematic diagram illustrating an example of controlling a roller according to embodiments;

FIG. 11 is a flowchart illustrating a secondary battery manufacturing method according to embodiments; and

FIG. 12 is a schematic diagram illustrating an example of controlling a roller according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Further, the use of “may” when describing embodiments relates to “one or more embodiments.”

References to two compared elements, features, etc. as being “the same,” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component may be interposed between the component and any arbitrary element disposed (or located or positioned) on (or under) the component.

In addition, it will be understood that, when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless specified otherwise. That is, “and/or” includes any or all combinations of a plurality of items enumerated. When “C to D” is stated, it means C or more and D or less, unless specified otherwise.

The terminology used herein is for the purpose of describing embodiments and is not intended to be limiting of embodiments.

### Lithium Secondary Battery

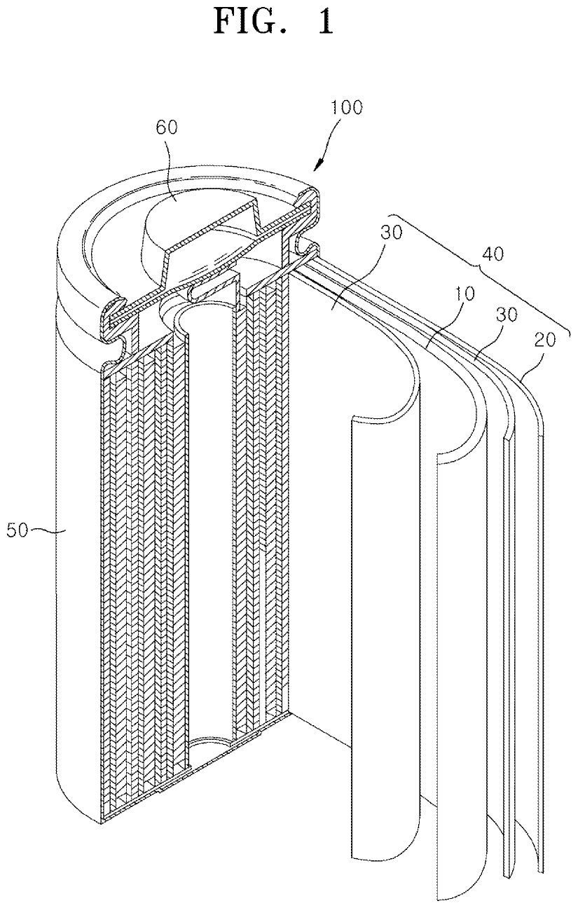

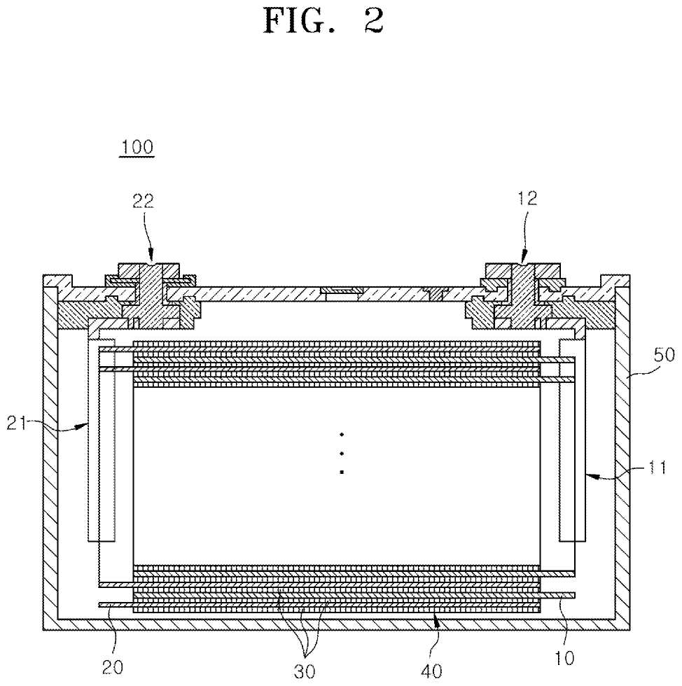

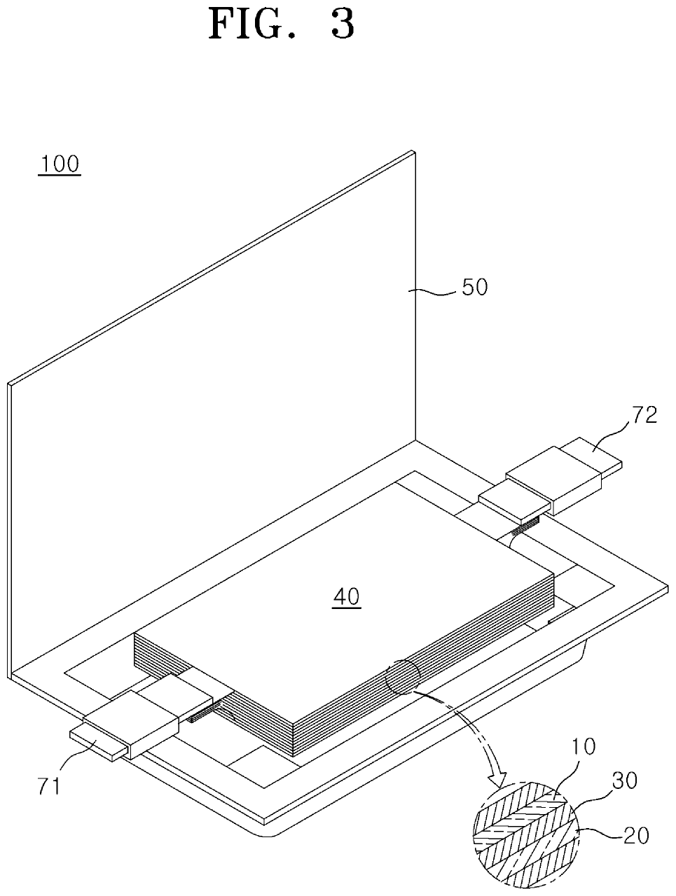

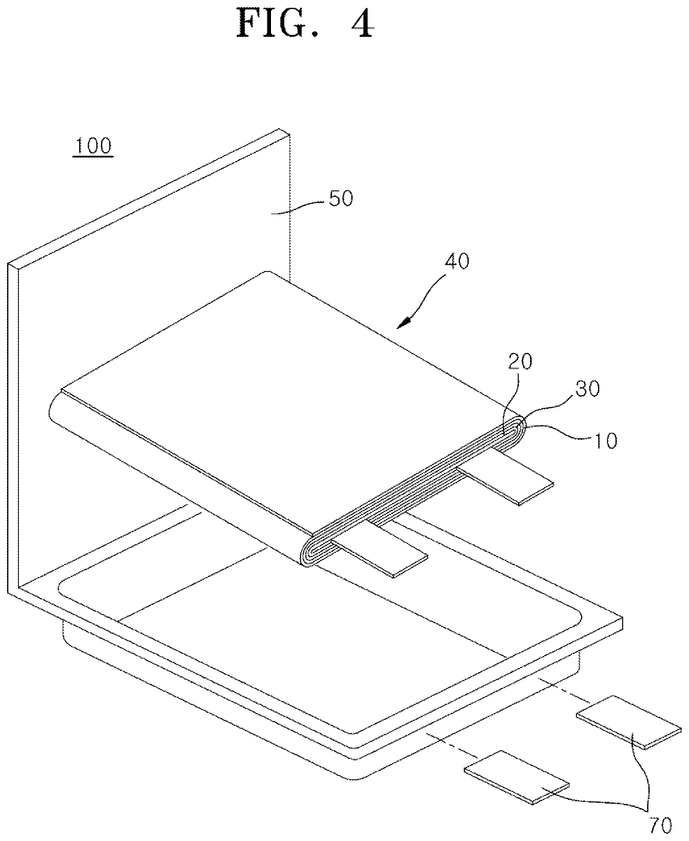

Lithium secondary batteries may be classified into, e.g., a cylindrical secondary battery, a faceted secondary battery, a pouch type secondary battery, a coin type secondary battery, and the like based on the shapes thereof. FIG. 1 to FIG. 4 are schematic views of lithium secondary batteries according to embodiments, in which FIG. 1 shows a cylindrical secondary battery, FIG. 2 shows a faceted secondary battery, and FIG. 3 and FIG. 4 show pouch-type secondary batteries.

Referring to FIG. 1 to FIG. 4, a lithium secondary battery 100 may include an electrode assembly 40 that includes a separator 30 interposed between a cathode 10 and an anode 20, and a case 50 that receives the electrode assembly 40 therein. The cathode 10, the anode 20, and the separator 30 may be embedded in an electrolyte.

For example, as illustrated in FIG. 1, the lithium secondary battery 100 may include a sealing member 60 that seals the case 50. In addition, as illustrated in FIG. 2, the lithium secondary battery 100 may include a cathode lead tab 11, a cathode terminal 12, an anode lead tab 21, and an anode terminal 22. As illustrated in FIG. 3 and FIG. 4, the lithium secondary battery 100 may include electrode tabs 70, i.e., a cathode tab 71 and an anode tab 72, which act as electrical pathways conducting current formed in the electrode assembly 40 to the outside.

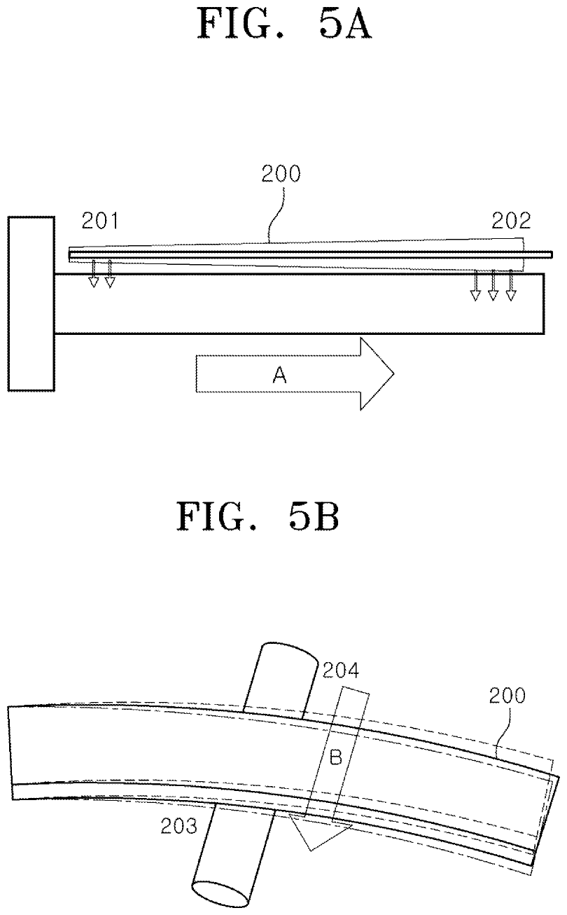

Hereinafter, referring to FIG. 5 to FIG. 12, a method of manufacturing the lithium secondary battery 100 described in FIG. 1 to FIG. 4 will be described. For example, referring to FIG. 5 to FIG. 12, a method for manufacturing an electrode plate and/or a separator included in the lithium secondary battery 100 described in FIG. 1 to FIG. 4 will be described.

It should be understood that the secondary battery manufacturing apparatus and/or method described with reference to FIG. 5 to FIG. 12 is applicable to any apparatus for manufacturing a sheet. The sheet refers to a thin plate or a structure, which has a longer length in one direction than in another direction (e.g., than in a perpendicular direction) and is subjected to tension in at least one direction. The sheet includes, e.g., an electrode plate, a separator, and the like, used in a secondary battery. Hereinafter, an object for the manufacturing apparatus and/or the manufacturing method according to embodiments will be referred to as a “sheet” for convenience of description.

FIG. 5A and FIG. 5B illustrate a view of an example of skew failure occurring in a sheet.

In FIG. 5A and FIG. 5B, reference numeral 200 denotes a sheet. In FIG. 5A and FIG. 5B, arrows A, B indicate directions in which the sheet 200 undergoes skew failure. FIG. 5A and FIG. 5B show all conveyance states of the sheet 200 in the manufacturing process. For example, all states of the sheet 200 before and after rolling, winding or unwinding, and before notching or slitting are shown therein.

For example, referring to FIG. 5A, the sheet 200 having a first side 201 with a different thickness (e.g., smaller in a cross-sectional view) than a second side 202 thereof may have an imbalance between the first and second sides 201 and 202 thereof. As such, the sheet 200 may undergo skew failure due to the difference in thickness between the first and second sides 201 and 202 in direction A.

In another example, referring to FIG. 5B, the sheet 200 having a third side 203 that has a shorter length than a fourth side 204 thereof (e.g., in a plan view) may cause an imbalance between the third and fourth sides 203 and 204 thereof. Accordingly, the sheet 200 becomes slanted and undergoes skew failure in direction B due to the imbalance thereof.

The causes of skew failure of the sheet 200 are not limited to the examples shown in FIG. 5A and FIG. 5B. The following description will focus on a method of manufacturing the sheet 200 without skew failure due to such various causes.

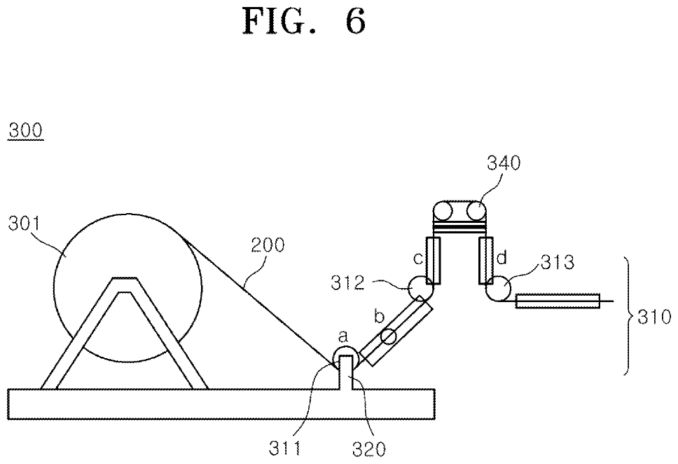

FIG. 6 is a schematic view of a secondary battery manufacturing apparatus according to embodiments. In FIG. 6, reference numeral 300 denotes the secondary battery manufacturing apparatus according to embodiments.

Referring to FIG. 6, the secondary battery manufacturing apparatus 300 according to embodiments refers to any device implementing operations in a process of conveying the sheet 200 of FIGS. 5A and 5B. For example, the secondary battery manufacturing apparatus 300 may perform a rolling function, e.g., the secondary battery manufacturing apparatus 300 may convey the sheet 200 toward a rolling roller that performs rolling of the sheet 200 or may convey the sheet 200 from a rolled state on the rolling roller. In another example, the secondary battery manufacturing apparatus 300 may perform a notching function, e.g., the secondary battery manufacturing apparatus 300 may convey the sheet 200 toward a mold for a notching operation of the sheet 200 or may convey the sheet 200 (in a notched state) from the mold. In yet another example, the secondary battery manufacturing apparatus 300 may be a conveyance device, e.g., the secondary battery manufacturing apparatus 300 may convey the sheet 200 from one working device toward another working device. As such, the secondary battery manufacturing apparatus 300 may include any device that functions as a conveyance device for the sheet 200 or performs conveyance as a process within the secondary battery manufacturing apparatus 300.

For example, as illustrated in FIG. 6, the secondary battery manufacturing apparatus 300 may include a roller 310, a driver 320, and a sensor (e.g., a, b, c, or d). The secondary battery manufacturing apparatus 300 may further include an unwinder 301. The secondary battery manufacturing apparatus 300 may further include an edge pivot controller (EPC) 340. The secondary battery manufacturing apparatus 300 may further include additional components, e.g., a communication unit capable of wired or wireless, short- or long-range communication with an external server, device, and the like. For example, the secondary battery manufacturing apparatus 300 may further include a memory storing instructions for operation of the secondary battery manufacturing apparatus 300.

The configuration of FIG. 6 enables the secondary battery manufacturing apparatus 300 to convey the sheet 200 while preventing skew failure of the sheet 200. Hereinafter, each component of the secondary battery manufacturing apparatus 300 will be described by way of example.

The unwinder 301 is a device for unwinding the wound sheet 200. To this end, the unwinder 301 may include an unwinding shaft and an unwinding roller. The unwinding roller rotates about the unwinding shaft in one direction. As the unwinding roller rotates, the sheet 200 wound around the unwinding roller is unwound in one direction. With this structure, the unwinder 301 allows the sheet 200 to be supplied to a device or location where the sheet 200 is required.

The roller 310 may convey the sheet 200. For example, the roller 310 may convey the sheet 200 in a preset direction or may convey the sheet 200 while reversing a traveling direction of the sheet 200. In another example, the roller 310 may convey the sheet 200 while rolling the sheet 200 through two or more rollers.

To this end, the roller 310 rotates about the roller shaft in one direction. A rotating direction of the roller 310 may be set based on the traveling direction of the sheet 200. For example, in order to convey the sheet 200 moving along a surface of the roller 310 in the counterclockwise direction, the roller 310 rotates about the roller shaft in the counterclockwise direction.

For example, as illustrated in FIG. 6, the roller 310 may include a first roller 311, a second roller 312, and a third roller 313. In another example, the roller 310 may include only one roller or may include four or more rollers. The first roller 311 may convey the sheet 200 while changing the traveling direction of the sheet 200. The second roller 312 may convey the sheet 200 toward a predetermined component (e.g., toward the EPC 340). The third roller 313 may convey the sheet 200 away from the predetermined component (e.g., away from the EPC 340). It should be noted that the roles performed by the first roller 311, the second roller 312, and/or the third roller 313 may be the same or different from each other.

The sensor may measure tension of the sheet 200. For example, the sensor may measure tension at one or more locations on the sheet 200 (e.g., via corresponding one or more sensor parts). The sensor may be provided to at least a portion of the secondary battery manufacturing apparatus 300 to measure the tension applied to the sheet 200. For example, the sensor may include a plurality of sensor parts to measure tension at different parts of the sheet 200 (e.g., a first part a, a second part b, a third part c, and a fourth part d positioned at different parts of the sheet 200).

For example, as illustrated in FIG. 6, the first part a of the sensor may be disposed on a roller (e.g., on the first roller 311), the second part b of the sensor may be disposed between rollers (e.g., between the first roller 311 and the second roller 312), the third part c of the sensor may be disposed before the EPC 340, and/or the fourth part d of the sensor may be disposed at any locations on a conveyance path of the sheet 200 (e.g., after the EPC 340). In another example, any number and/or combination of the first through fourth parts of the sensor may be arranged along the conveyance path of the sheet 200. For example, the sensor (e.g., each of the first through fourth parts a, b, c, and/or d) may include a load cell.

The driver 320 may control operation of the roller 310. The driver 320 may control operation of the roller 310 based on the measured tension. For example, the driver 320 may control a rotational speed of the roller 310 (e.g., the driver 320 may increase, maintain, or decrease the rotational speed of the roller 310 based on the measured tension). In another example, the driver 320 may control a moving angle of the roller 310 (e.g., based on the measured tension, the driver 320 may adjust the roller shaft of the roller 310 to have a positive angle relative to the ground, adjust the roller shaft of the roller 310 to be parallel to the ground, or adjust the roller shaft of the roller 310 to have a negative angle relative to the ground). For example, the driver 320 may be a central processing unit (CPU), a microprocessor unit (MPU), a microcontroller unit (MCU), a graphics processing unit (GPU), a digital signal processor (DSP), a floating-point unit (FPU), an application specific integrated circuit (ASIC), or a field programmable gate array (FPGA).

For example, as illustrated in FIG. 6, the driver 320 may be disposed near the roller 310 (e.g., the first roller 311) to control operation of the roller 310 (e.g., the first through third rollers 311 through 313). In another example, the driver 320 may be placed away from the roller 310 or may be placed outside the secondary battery manufacturing apparatus 300 to control all or some of the components included in the secondary battery manufacturing apparatus 300 through wired or wireless communication.

The EPC 340 may include a pivot type EPC and may independently perform compensation for skew failure of the sheet 200. For example, the EPC 340 may compensate for skew failure of the sheet 200 through accurate control of a pivot angle. In another example, the EPC 340 may perform all or some of functions performed by the driver 320. As such, the EPC 340 may allow compensation for skew failure of the sheet 200 in the secondary battery manufacturing apparatus 300 to be more effectively performed. As such, the secondary battery manufacturing apparatus 300 according to embodiments minimizes skew failure of the sheet 200 by controlling operation of the roller 310 based on the tension of the sheet 200.

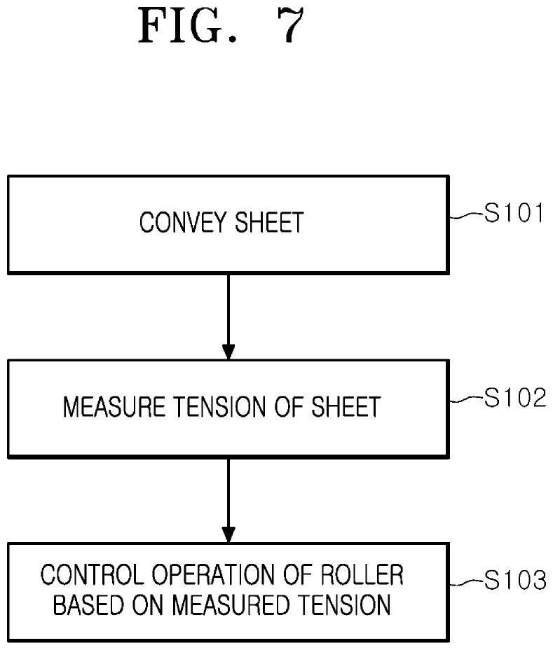

Referring to FIG. 7, a process for preventing skew failure will be described in more detail. FIG. 7 is a flowchart illustrating a secondary battery manufacturing method according to embodiments.

The manufacturing method described with reference to FIG. 7 may be performed not only by the secondary battery manufacturing apparatus 300 according to the embodiment described with reference to FIG. 6, but also by a system including separate devices capable of performing each operation or by other devices capable of performing each operation. That is, an entity capable of implementing the secondary battery manufacturing method according to the embodiment described with reference to FIG. 7 is not limited to the secondary battery manufacturing apparatus 300. However, in FIG. 7 and the following description, for convenience of description, the secondary battery manufacturing method according to the embodiment performed by the secondary battery manufacturing apparatus 300 will be described by way of example.

Referring to FIGS. 6 and 7, the secondary battery manufacturing method may include conveying the sheet 200 (S101). According to an embodiment, the roller 310 may convey the sheet 200. Conveyance of the sheet 200 is the same as or similar to that described with reference to FIG. 6.

Referring to FIGS. 6 and 7, the secondary battery manufacturing method may include measuring tension of the sheet 200 (S102). That is, the sensor (i.e., the first through fourth parts of the sensor a, b, c, and d in FIG. 6) according to embodiments may measure data about the sheet 200, e.g., the first through fourth parts a, b, c, and d of the sensor may measure tension of the sheet 200 in four different corresponding locations on the sheet 200.

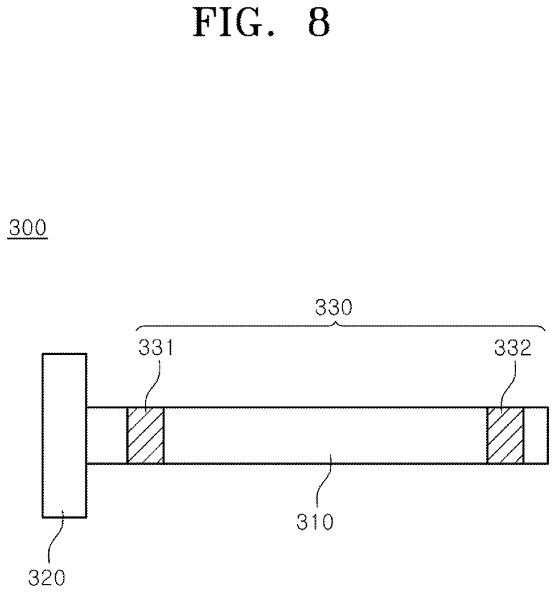

For example, the sheet 200 may be under conveyance or stopped. The data about the sheet 200 may include, e.g., tension that the sheet 200 receives from the secondary battery manufacturing apparatus 300 or from an external source during conveyance of the sheet 200. The first through fourth parts a, b, c, and d of the sensor may include any sensing devices capable of measuring data about the sheet 200. For example, each of the first through fourth parts a, b, c, and d of the sensor may calculate tension of the sheet 200 through a method of measuring tension through a load cell, a method of measuring tension through lift-off, a method of measuring a vibration signal through an accelerometer to calculate tension based on the natural frequency, a method of estimating relative permeability through a solenoid to calculate tension, and a method of estimating tension through sag measurement. The method of measuring tension using the first through fourth parts a, b, c, and d of the sensor will be described below in more detail with reference to FIG. 8.

As shown in FIGS. 6 and 7, the secondary battery manufacturing method may include controlling operation of the roller 310 based on the measured tension (S103).

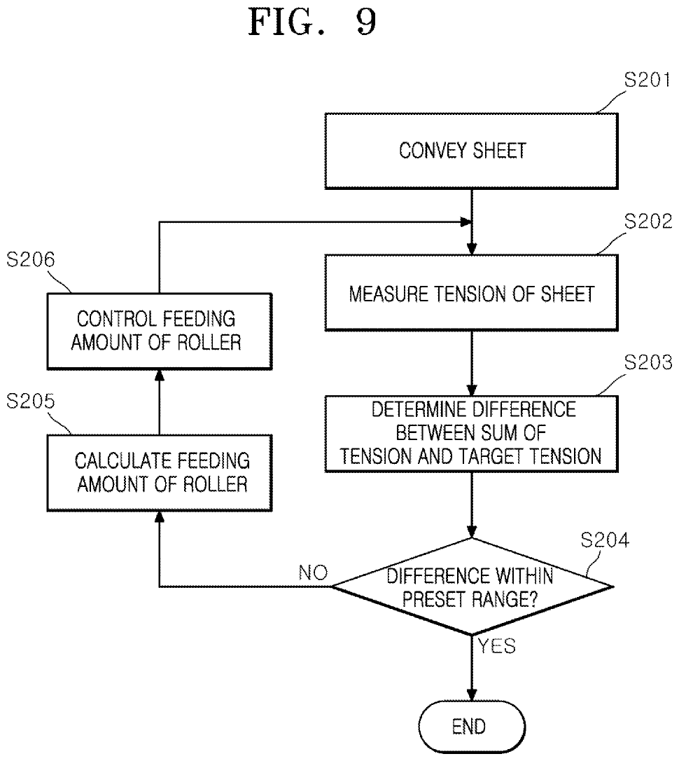

The driver 320 according to the embodiments may control operation of the roller 310 to minimize occurrence of skew failure of the sheet 200 based on the tension of the sheet 200 measured in operation (S102). For example, the driver 320 may control the moving angle of the roller 310 or a feeding amount of the roller 310 to minimize occurrence of skew failure of the sheet 200. Controlling operation of the roller 310 will be described in more detail below with reference to FIG. 9 to FIG. 12.

In this way, the secondary battery manufacturing apparatus and/or the secondary battery manufacturing method according to the embodiments improves process capability through direct measurement of tension on a traveling path of the sheet.

FIG. 8 is a schematic view of a secondary battery manufacturing apparatus according to embodiments. In FIG. 8, reference numeral 300 denotes the secondary battery manufacturing apparatus described with reference to FIG. 6 and FIG. 7.

As described above, the secondary battery manufacturing apparatus 300 according to embodiments may include the roller 310 and the driver 320 that controls operation of the roller 310. The secondary battery manufacturing apparatus 300 may further include a sensor 330. The sensor 330 may include the first through fourth parts a, b, c, and d described previously with reference to FIG. 6, and may measure the tension of the sheet 200 while the sheet 200 is conveyed by the roller 310.

As described with reference to FIG. 7, the sensor 330 may be or may include, e.g., load cells. If the sensor 330 includes load cells, the sensor 330 may be used as a replacement for the roller 310.

For example, referring to FIG. 6, the sensor 330 (i.e., the plurality of first through fourth parts a, b, c, and d of the sensor in FIG. 6) may be arranged on (e.g., along) the roller 310. For example, two or more parts of the sensor 330 may be mounted on one roller 310. For example, as illustrated in FIG. 6, the sensor 330 may include first through fourth parts a, b, c, and d arranged along the path of the sheet 200. In another example, as illustrated in FIG. 8, the sensor 330 may include a first sensor 331 and a second sensor 332 arranged along the path of the sheet 200.

For example, the first sensor 331 may be mounted on a first side of the roller 310, e.g., the first side of the roller 310 may correspond to a first side of the sheet 200 conveyed by the roller 310. With this structure, the first sensor 331 may measure tension on the first side of the sheet 200.

For example, the second sensor 332 may be mounted on a second side of the roller 310. The second side of the roller 310 may be spaced apart from the first side of the roller 310 by a predetermined distance. For example, if the first side of the roller 310 is at a right side of the roller 310, the second side of the roller 310 is at a left side of the roller 310. With this structure, the second sensor 332 may measure tension on the second side of the sheet 200. Accordingly, the second sensor 332 may be spaced apart from the first sensor 331 by a predetermined distance.

With this arrangement, the sensor 330 may measure tension on at least two portions of the sheet 200 via the first and second sensors 331 and 332. The driver 320 may calculate the sum of tension on the first side of the sheet 200 and tension on the second side of the sheet 200 via the first and second sensors 331 and 332 or balance therebetween to control operation of the roller 310 in a direction of reducing a deviation in tension therebetween.

Accordingly, the secondary battery manufacturing apparatus and/or the secondary battery manufacturing method according to the embodiments analyze and/or suppress skew failure that occurs in the sheet 200.

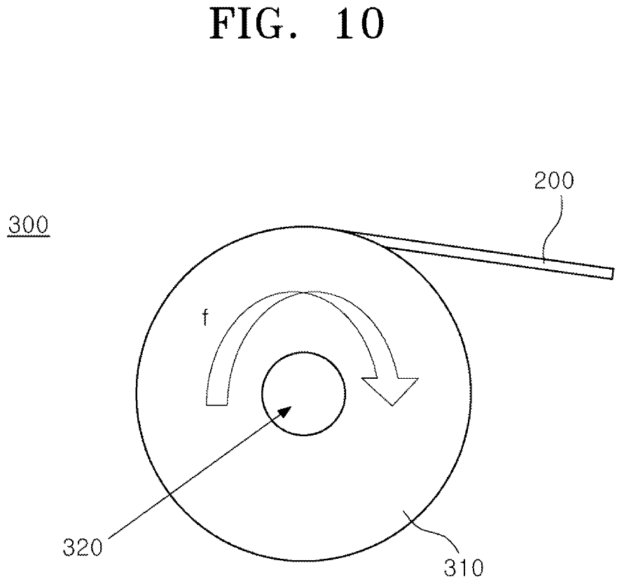

FIG. 9 is a flowchart illustrating a secondary battery manufacturing method according to an embodiment. FIG. 10 is a schematic diagram illustrating an example of controlling operation of a roller according to an embodiment.

The method of controlling operation of the roller 310 based on the tension measured by the driver 320 is described above with reference to FIG. 6 to FIG. 8. As one example of the method of controlling operation of the roller 310, control of the feeding amount of the roller 310 based on the tension measured by the driver 320 will be described in detail with reference to FIG. 9 and FIG. 10.

Referring to FIG. 9, the secondary battery manufacturing method may include conveying the sheet 200 (S201). The description of operation (S201) is the same as or similar to the description of operation (S101) with reference to FIG. 6 and FIG. 7.

Referring to FIG. 9, the secondary battery manufacturing method may include the measuring tension of the sheet 200 (S202). The description of operation (S202) is the same as or similar to the description of operation (S102) with reference to FIG. 6 and FIG. 7.

Referring to FIG. 9, the secondary battery manufacturing method may include determining a difference between the sum of the measured tensions and a target tension (S203). The driver 320 may calculate the sum of the measured tensions. The sum of the tensions is the sum of tensions measured in at least two different regions on the sheet 200.

The driver 320 may determine a difference between the sum of the measured tensions and the target tension. Here, the target tension is the sum of tensions measured in at least two regions of the sheet 200 if the sheet 200 is conveyed without skew failure. For example, the target tension may be a preset value stored in a memory (e.g., the memory described with reference to FIG. 6) or a value received from an external source via a communication unit (e.g., the communication unit described with reference to FIG. 6).

For example, the driver 320 may calculate an absolute value of the sum of the measured tensions subtracted from the target tension. The calculated absolute value is the difference between the sum of the tensions and the target tension.

Referring to FIG. 9, the secondary battery manufacturing method may include determining whether the difference is within a preset range (S204). The driver 320 may determine whether the difference calculated in operation (S203) is within a preset range (first range).

Here, the preset range may be the same as or a similar range to the target tension. The preset range may be a range within which it is determined that the sheet 200 is not in a skew failure state. The preset range may be greater than or equal to zero (and may include zero). If the preset range is 0, the driver 320 may determine that the sum of the measured tensions is within the preset range only if the sum of the measured tensions is equal to the target tension (within a decimal point range that can be measured by the sensor 330 and/or calculated by the driver 320).

The driver 320 may not control operation of the roller 310 if the difference calculated in operation (S203) is within the preset range. Here, the driver 320 may determine that the sheet 200 does not undergo skew failure.

Referring to FIG. 9, the secondary battery manufacturing method may include calculating the feeding amount of the roller 310 upon determining that the difference is not within the preset range (S205). The driver 320 may calculate the feeding amount of the roller 310 in order to control operation of the roller 310 upon determining that the difference calculated in operation (S203) is not within the preset range.

Here, the feeding amount of the roller 310 may relate to the rotational speed of the roller 310. The feeding amount of roller 310 refers to a length of sheet 200 (e.g., or weight, mass or any other physical quantity from which the conveying speed of the sheet 200 can be calculated) that is conveyed through roller 310 per hour. For example, the feeding amount of the roller 310 may increase with increasing rotational speed of the roller 310. For example, the feeding amount of the roller 310 may decrease with decreasing rotational speed of the roller 310.

For example, upon determining that the sum of the measured tensions is greater than the target tension, the driver 320 may calculate the feeding amount of the roller 310 such that the feeding amount of the roller 310 decreases. Here, “decrease” means that the feeding amount decreases with reference to a current feeding amount. In another example, upon determining that the sum of the measured tensions is less than the target tension, the driver 320 may calculate the feeding amount of the roller 310 such that the feeding amount of the roller 310 increases. Here, “increase” means that the feeding amount increases with reference to the current feeding amount.

Referring to FIG. 9, the secondary battery manufacturing method may include controlling the feeding amount of the roller 310 (S206). For example, if the driver 320 calculates the feeding amount of the roller in operation (S205) such that the feeding amount of the roller 310 increases, the driver 320 may increase the rotational speed of the roller 310 such that the sheet 200 is conveyed faster (more) through the roller 310. For example, the roller 310 rotates faster in a direction f shown in FIG. 10.

For example, if the driver 320 calculates the feeding amount of the roller in operation (S205) such that the feeding amount of the roller 310 decreases, the driver 320 decreases the rotational speed of the roller 310 such that the sheet 200 is conveyed slower (less) through the roller 310. For example, the roller 310 may rotate slower in the direction f shown in FIG. 10.

As such, the secondary battery manufacturing apparatus and/or the secondary battery manufacturing method according to the embodiments measure tension and use the measured tension to perform a feedback action to prevent skew failure of the sheet. As a result, the embodiments minimize skew failure of the sheet 200.

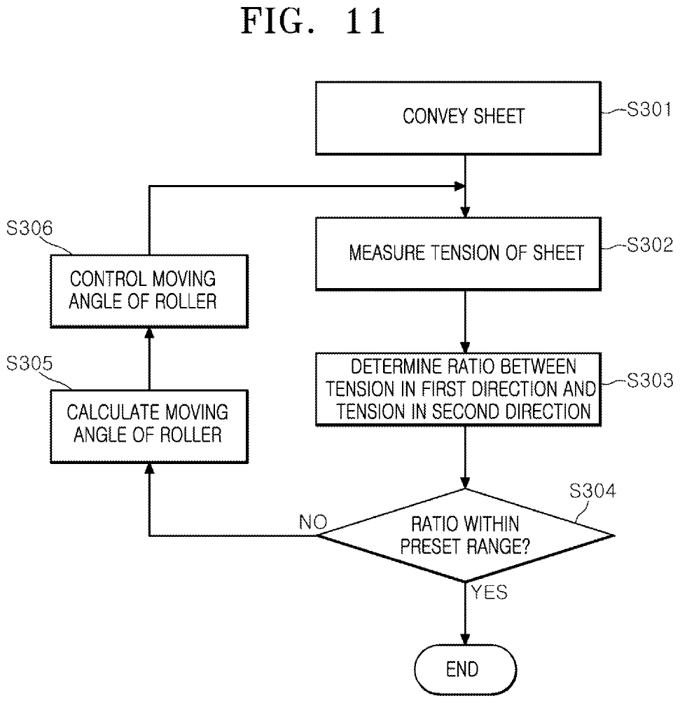

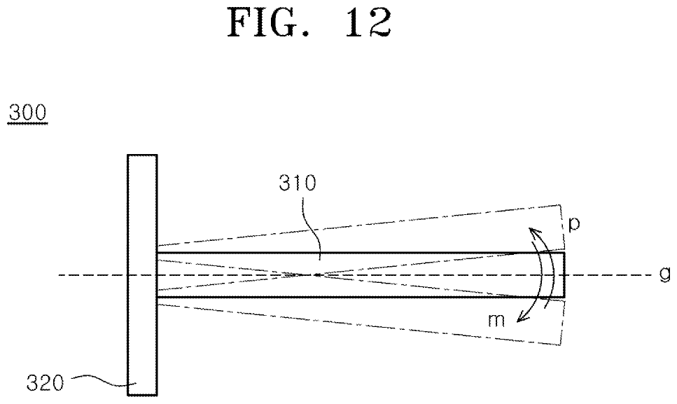

FIG. 11 is a flowchart illustrating a secondary battery manufacturing method according to embodiments. FIG. 12 is a schematic diagram illustrating an example of controlling operation of a roller according to embodiments.

The method of controlling operation of the roller 310 based on the tension measured by the driver 320 is described above with reference to FIG. 6 to FIG. 8. Next, another method of controlling operation of the roller 310, e.g., via controlling a moving angle of the roller 310 based on the tension measured by the driver 320, will be described in detail with reference to FIG. 11 and FIG. 12.

Referring to FIG. 11, the secondary battery manufacturing method may include conveying the sheet 200 (S301). The description of operation (S301) is the same as or similar to the description of the operation (S101) with reference to FIG. 6 and FIG. 7.

Referring to FIG. 11, the secondary battery manufacturing method may include measuring tension of the sheet 200 (S302). The description of operation (S302) is the same as or similar to the description of operation (S102) with reference to FIG. 6 and FIG. 7.

Referring to FIG. 11, the secondary battery manufacturing method may include determining a ratio between tension in a first direction and tension in a second direction (S303). The driver 320 may calculate the tension in the first direction and the tension in the second direction based on the measured tensions. The first direction and/or the second direction correspond to, e.g., the first side and the second side described with reference to FIG. 8. The driver 320 determines the ratio between the tension in the first direction and the tension in the second direction. For example, the ratio is a value obtained by dividing the tension in the first direction by the tension in the second direction.

Referring to FIG. 11, the secondary battery manufacturing method may include determining whether the ratio determined in operation (S303) is within a preset range (S304). The driver 320 determines whether the ratio between the tension in the first and the tension in the second directions is within a preset range (second range). Here, the preset range is a range within which it is determined that the sheet 200 is not in a skew failure state. For example, the preset range may be in the range of 0.9 to 1.1 and may include 1. For example, if the preset range is 1, the driver 320 may determine that skew failure does not occur only if the tension in the first direction is equal to the tension in the second direction (within a decimal point range that can be measured by the sensors 330 and/or calculated by the driver 320).

The driver 320 may not control operation of the roller 310 if the ratio between the tension in the first direction and the tension in the second direction is within the preset range. Here, the driver 320 may determine that the sheet 200 does not undergo skew failure.

Referring to FIG. 11, the secondary battery manufacturing method may include calculating the moving angle of the roller 310 upon determining that the difference is outside the preset range. The driver 320 may calculate the moving angle of the roller 310 in order to control operation of the roller 310, upon determining that the ratio calculated in operation (S302) is outside the preset range.

Here, the moving angle of the roller 310 refers to an angle of a rotational axis of the roller 310 with respect to the ground. For example, if the rotational axis of the roller 310 is parallel to the ground, the moving angle of the roller 310 is denoted by g in FIG. 12. For example, if the rotational axis of the roller 310 is at a positive angle relative to the ground, the moving angle of the roller 310 is denoted by p in FIG. 12. For example, if the rotational axis of the roller 310 is at a negative angle relative to the ground, the moving angle of the roller 310 is denoted by m in FIG. 12.

For example, upon determining that the tension in the first direction is greater than the tension in the second direction, the driver 320 may calculate the moving angle of the roller 310 as a first angle. The first angle may be one of angles at which the second direction of the roller 310 is placed above the first direction of the roller 310. For example, upon determining that the tension in the first direction is less than the tension in the second direction, the driver 320 may calculate the moving angle of the roller 310 as a second angle. The second angle may be one of angles at which the second direction of the roller 310 is placed below the first direction of the roller 310.

Referring to FIG. 11, the secondary battery manufacturing method may include controlling the moving angle of the roller 310 (S306). For example, the driver 320 may control the moving angle of the roller 310 according to the value calculated in operation (S305). Accordingly, the roller 310 has the moving angle controlled, e.g., in the direction m or the direction p in FIG. 12.

By way of summation and review, in the process of conveying the electrode plate or the separator, skew failure may occur, in which the electrode plate or the separator is skewed to one side and becomes unbalanced, thereby causing winding failure or uneven formation of the electrode plate or the separator. As a result, a short circuit may be triggered within the secondary battery. Therefore, it is desired to prevent skew failure of the electrode plate or the separator.

It is an aspect of embodiments to provide an apparatus and method for manufacturing a secondary battery, which can prevent or substantially minimize skew failure of an electrode plate or a separator. As such, the secondary battery manufacturing apparatus and/or the secondary battery manufacturing method according to the embodiments includes positioning sensors along the traveling path of the sheet (of the electrode plate or separator) to measure tension at different positions on the sheet, and performing feedback actions using the measured tensions to prevent skew failure. As a result, the embodiments minimize skew failure of the sheet.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery manufacturing apparatus, comprising:
at least one roller configured to convey a sheet;
at least one sensor configured to measure a tension of the sheet; and
a driver configured to control operation of the at least one roller, based on the tension measured by the at least one sensor.

2. The secondary battery manufacturing apparatus as claimed in claim 1, wherein:
the at least one roller includes a first roller and a second roller, and
the at least one sensor is positioned at least at one of a portion of the first roller, a portion of the second roller, and a portion between the first roller and the second roller.

3. The secondary battery manufacturing apparatus as claimed in claim 1, wherein the at least one sensor includes a first sensor on a first side of the at least one roller and a second sensor on a second side of the at least one roller, the first sensor and the second sensor being spaced apart from each other by a predetermined distance.

4. The secondary battery manufacturing apparatus as claimed in claim 1, wherein the driver is configured to control operation of the at least one roller by controlling at least one of a feeding amount of the at least one roller and a moving angle of the at least one roller based on the tension measured by the at least one sensor.

5. The secondary battery manufacturing apparatus as claimed in claim 1, wherein the driver is configured to calculate a sum of the tension measured by the at least one sensor, to determine a difference between the sum of the tension measured by the at least one sensor and a target tension, and to control operation of the at least one roller based on whether the difference is within a first range.

6. The secondary battery manufacturing apparatus as claimed in claim 5, wherein, if determining that the difference is not within the first range:
the driver is configured to control operation of the at least one roller so as to decrease a feeding amount of the at least one roller if the sum of the tension measured by the at least one sensor is greater than the target tension, and
the driver is configured to control operation of the at least one roller so as to increase the feeding amount of the at least one roller if the sum of the tension measured by the at least one sensor is less than the target tension.

7. The secondary battery manufacturing apparatus as claimed in claim 1, wherein the driver is configured to determine a ratio of tension in a first direction of the sheet and tension in a second direction of the sheet based on the tension measured by the at least one sensor, and is configured to control the driving of the at least one roller based on whether the determined ratio is within a second range.

8. The secondary battery manufacturing apparatus as claimed in claim 7, wherein, if determining that the determined ratio is not within the second range:
the driver is configured to adjust a moving angle of the at least one roller to a first angle if the tension in the first direction is greater than the tension in the second direction, and
the driver is configured to adjust the moving angle of the at least one roller to a second angle, if the tension in the first direction is less than the tension in the second direction.

9. The secondary battery manufacturing apparatus as claimed in claim 1, wherein the at least one sensor includes a load cell.

10. A secondary battery manufacturing method, comprising:
conveying a sheet through at least one roller;
measuring tension of the sheet through at least one sensor during conveyance of the sheet; and
controlling operation of the at least one roller, based on the measured tension, through a driver.

11. The secondary battery manufacturing method as claimed in claim 10, wherein the at least one sensor includes a load cell.

12. The secondary battery manufacturing method as claimed in claim 10, wherein controlling operation of the at least one roller includes:
calculating a sum of measured tensions;
determining a difference between the sum of the measured tensions and a target tension; and
controlling operation of the at least one roller based on whether the difference is within a first range.

13. The secondary battery manufacturing method as claimed in claim 12, wherein, if determining that the difference is not within the first range, controlling operation of the at least one roller includes:
controlling operation of the at least one roller so as to decrease a feeding amount of the at least one roller if the sum of the measured tensions is greater than the target tension; and
controlling operation of the at least one roller so as to increase the feeding amount of the at least one roller if the sum of the measured tensions is less than the target tension.

14. The secondary battery manufacturing method as claimed in claim 10, wherein controlling operation of the at least one roller includes:
determining a difference between a ratio of tension in a first direction of the sheet and tension in a second direction of the sheet based on the measured tension; and
controlling operation of the at least one roller based on whether the determined difference is within a second range.

15. The secondary battery manufacturing method as claimed in claim 14, wherein, upon determining that the difference is not within the second range, controlling operation of the at least one roller includes:
adjusting a moving angle of the at least one roller to a first angle if the tension in the first direction is greater than the tension in the second direction, and
adjusting the moving angle of the at least one roller to a second angle if the tension in the first direction is less than the tension in the second direction.
